(19) United States
(12) Patent Application Publication
(10) Pub. No.: US 2006/0273915 A1
(43) Pub. Date: Dec. 7, 2006

(54) Hand wash and sanitization monitoring system

(76) Inventor: David L. Snodgrass, Stuart, FL (US)

Correspondence Address: COOPER & DUNHAM, LLP, 1185 AVENUE OF THE AMERICAS, NEW YORK, NY, 10036, US

(21) Appl. No.: 11/146,955

(22) Filed: Jun. 7, 2005

(51) Int. Cl. G08B 23/00

(52) U.S. Cl. 340/573.1; 222/52

(57) ABSTRACT

A hand wash and sanitization monitoring system and method for tracking hand washing and sanitizing. A person must wash her hands according to predetermined hand wash and sanitization procedures as set forth by visual and audible prompts issued by a base unit in order to advance a wash and sanitization count.

### BACKGROUND OF THE INVENTION

1. Field of the Invention

The present invention relates to a method and apparatus for hand wash and sanitization monitoring systems. More particularly, this invention relates to a method and apparatus wherein persons are directed to wash and sanitize their hands in a step-by-step procedure to promote adherence to government and industry hygiene standards.

2. Description of Related Art

It is well known that maintaining a high level of employee hygiene is critical in the food service industry and healthcare professions, where the spread of bacteria and viruses can ultimately endanger a person's health. These industries must follow strict government and industry regulations requiring employees to wash and sanitize their hands before and after food preparation, after handling waste, after they enter a washroom, etc. An increasing number of industries, such as microprocessor fabricators, utilize “clean” rooms or sanitary areas that rival the sterile environment of a surgical operating room. Employees are required to wash and sanitize their hands according to a schedule and/or before re-entering the clean area once they have exited to avoid product contamination. As a general rule, most industries require employees to wash and sanitize their hands after any bathroom use. Many industries also require washing and sanitizing after an employee has entered any unsanitary area, such as a garbage disposal area or an infectious area in a hospital. Other industries may require employees to wash and sanitize their hands before entering a clean room or sterile room.

Numerous inventions such as touch-free, automatic soap dispensers, faucets and hand dryers attempt to address the problem of workplace hygiene by making it easier for employees to wash and sanitize their hands. Unless employees are actively supervised in the washroom, however, there is usually no way to determine whether they have washed their hands. Furthermore, even if the employees do wash their hands, there is no way to easily determine whether they have followed a prescribed government- and/or industry-approved regimen to ensure they washed and sanitized properly.

### OBJECTS OF THE INVENTION

It is an object of the current invention to solve the problems discussed above relating to monitoring employee hygiene. Specifically, it is an object of the current invention to provide a simple hand wash and sanitization monitoring system that will support predetermined hand wash and sanitization procedures.

### SUMMARY OF THE INVENTION

One embodiment of the present invention relates to a hand wash and sanitization monitoring system comprising: a wash area including a sanitizer dispenser for sanitizing hands of a person; and a base unit housed within the sanitizer dispenser for detecting when the person has correctly performed a predetermined hand sanitization procedure. The sanitizer dispenser is activated by one of hand proximity sensors and noncontaminating means. The base unit is equipped with one or more of visual means and audible means for displaying and/or advancing a hand sanitization count when the person has properly performed the predetermined hand sanitization procedure. The base unit is equipped with one or more of information storage means for performance data regarding the completion of the predetermined hand sanitization procedure. The base unit is equipped with one or more of communication means for later retrieval or for immediate or delayed transmission of performance data to a remote memory unit. In this embodiment, the hand wash and sanitization monitoring system further comprises means for preventing reactivation of the predetermined hand sanitization procedure for a predetermined period of time upon the base unit detecting the person has initiated the predetermined hand sanitization procedure.

Another embodiment of the present invention relates to a hand wash and sanitization monitoring system comprising: a wash area including a faucet for washing hands of a person; a soap and/or sanitizer dispenser for sanitizing hands of the person; and a base unit housed within the soap and/or sanitizer dispenser for detecting when the person has correctly performed a predetermined hand wash procedure. The soap and/or sanitizer dispenser is activated by one of hand proximity sensors and non-contaminating means. The base unit is equipped with one or more of visual means and audible means for prompting the person to perform the predetermined hand wash procedure; and for displaying and/or advancing a hand wash count when the person has properly performed the predetermined hand wash procedure. The base unit is equipped with one or more of information storage means for performance data regarding the completion of the predetermined hand wash procedure. The base unit is equipped with one or more of communication means for later retrieval or for immediate or delayed transmission of performance data to a remote memory unit.

In this embodiment, the hand wash and sanitization monitoring system further comprises means for deactivating the faucet for a predetermined period of time upon the base unit detecting the person has correctly performed a step in the predetermined hand wash procedure. The hand wash and sanitization monitoring system further comprises means for preventing reactivation of the predetermined hand wash procedure for a predetermined period of time upon the base unit detecting the person has correctly initiated the predetermined hand wash procedure.

Another embodiment of the present invention relates to a hand wash and sanitization monitoring system comprising: a wash area including a faucet for washing hands of a person; a soap and/or sanitizer dispenser for sanitizing hands of the person; and a base unit housed within the faucet and the soap and/or sanitizer dispenser for detecting when the person has correctly performed a predetermined hand wash procedure. The faucet and the soap and/or sanitizer dispenser are activated by one of hand proximity sensors and non-contaminating means. The base unit is equipped with one or more of visual means and audible means for prompting the person to perform the predetermined hand wash procedure; and for displaying and/or advancing a hand wash count when the person has properly performed the predetermined hand wash procedure. The base unit is equipped with one or more of information storage means for performance data regarding the completion of the predetermined hand wash procedure. The base unit is equipped with one or more of communication means for later retrieval or for immediate or delayed transmission of performance data to a remote memory unit.

In this embodiment, the hand wash and sanitization monitoring system further comprises means for deactivating the faucet for a predetermined period of time upon the base unit detecting the person has correctly performed a step in the predetermined hand wash procedure. The hand wash and sanitization monitoring system further comprises means for preventing reactivation of the predetermined hand wash procedure for a predetermined period of time upon the base unit detecting the person has correctly initiated the predetermined hand wash procedure.

Another embodiment of the present invention relates to a hand wash and sanitization monitoring system comprising: a wash area including a faucet for washing hands of a person; a soap and/or sanitizer dispenser for sanitizing hands of the person; and a base unit housed within the faucet and the soap and/or sanitizer dispenser for detecting when the person has correctly performed a predetermined hand wash procedure. The faucet and the soap and/or sanitizer dispenser in the wash area are activated by one of hand proximity sensors and non-contaminating means. The base unit is equipped with one or more of input means for inputting identification data of the person. The base unit is equipped with one or more of visual means and audible means for prompting the person to perform the predetermined hand wash procedure; and for displaying and/or advancing a hand wash count when the person has properly performed the predetermined hand wash procedure. The base unit is equipped with one or more of information storage means for performance data based upon the identification data regarding the completion of the predetermined hand wash procedure. The base unit is equipped with one or more of communication means for later retrieval or for immediate or delayed transmission of performance data to a remote memory unit.

In this embodiment, the hand wash and sanitization monitoring system further comprises means for deactivating the faucet for a predetermined period of time upon the base unit detecting the person has correctly performed a step in the predetermined hand wash procedure. The hand wash and sanitization monitoring system further comprises means for preventing reactivation of the predetermined hand wash procedure for a predetermined period of time upon the base unit detecting the person has correctly initiated the predetermined hand wash procedure.

Another embodiment of the present invention relates to a hand wash and sanitization monitoring method comprising the steps of: detecting whether a person has properly performed a predetermined hand sanitization procedure using a base unit located in a wash area; and advancing a hand sanitization count by the base unit when the person has properly performed the predetermined hand sanitization procedure.

Another embodiment of the present invention relates to a hand wash and sanitization monitoring method comprising the steps of: instructing a person to perform a predetermined hand wash procedure using a base unit located in a wash area; deactivating a faucet using the base unit upon detecting the person has properly performed a step in the predetermined hand wash procedure; detecting whether the person has properly performed the predetermined hand wash procedure using the base unit; and advancing a hand wash count by the base unit when the person has properly performed the predetermined hand wash procedure. The instructing step further includes the step of one or more of visually and audibly prompting the person to perform the predetermined hand wash procedure by the base unit.

Another embodiment of the present invention relates to a hand wash and sanitization monitoring method comprising the steps of: identifying a person by means of inputted identification data; instructing the person to perform a predetermined hand wash procedure using a base unit located in a wash area; deactivating a faucet using the base unit upon detecting the person has properly performed a step in the predetermined hand wash procedure; detecting whether the person has properly performed the predetermined hand wash procedure using the base unit; and advancing a hand wash count by the base unit when the person has properly performed the predetermined hand wash procedure. The instructing step further includes the step of one or more of visually and audibly prompting the person to perform the predetermined hand wash procedure by the base unit.

### BRIEF DESCRIPTION OF THE DRAWINGS

FIG. 1 shows a representative wash area according to an embodiment of the present invention;

FIG. 2 shows a representative dispenser unit according to an embodiment of the present invention;

FIG. 3 shows a representative base unit according to an embodiment of the present invention;

FIG. 4 is a flow chart diagram showing a representative hand sanitization procedure according to an embodiment of the present invention;

FIG. 5 is a flow chart diagram showing a representative hand wash and sanitization procedure according to an embodiment of the present invention;

FIG. 6 is a flow chart diagram showing a representative hand wash and sanitization procedure according to an embodiment of the present invention; and

FIG. 7 is a flow chart diagram showing a representative hand wash and sanitization procedure according to an embodiment of the present invention.

### DETAILED DESCRIPTION OF THE INVENTION

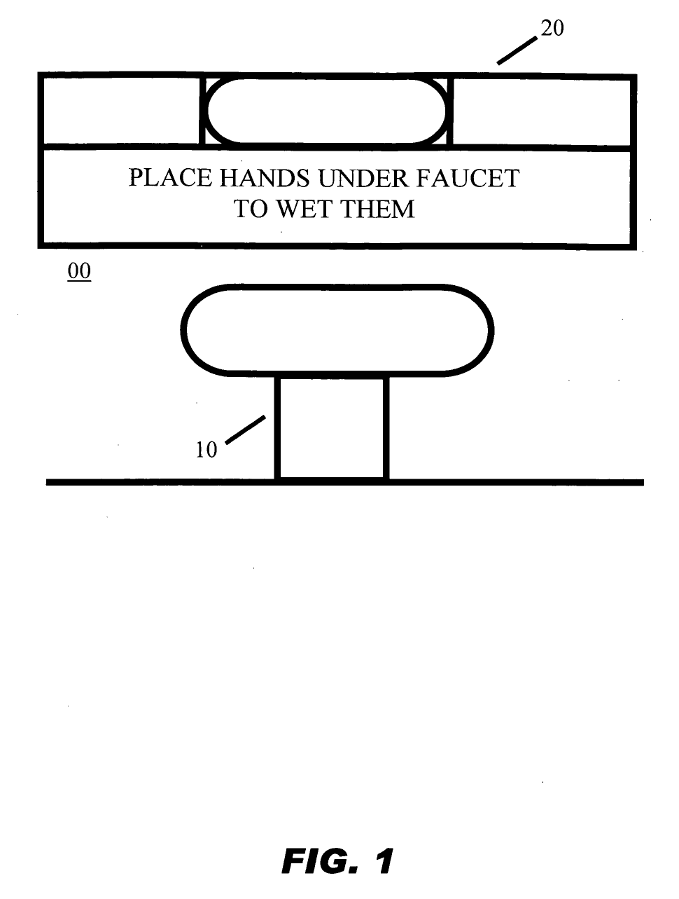

FIG. 1 shows a wash area 00 according to the present invention. Wash area 00 comprises a faucet 10 and a dispenser unit 20.

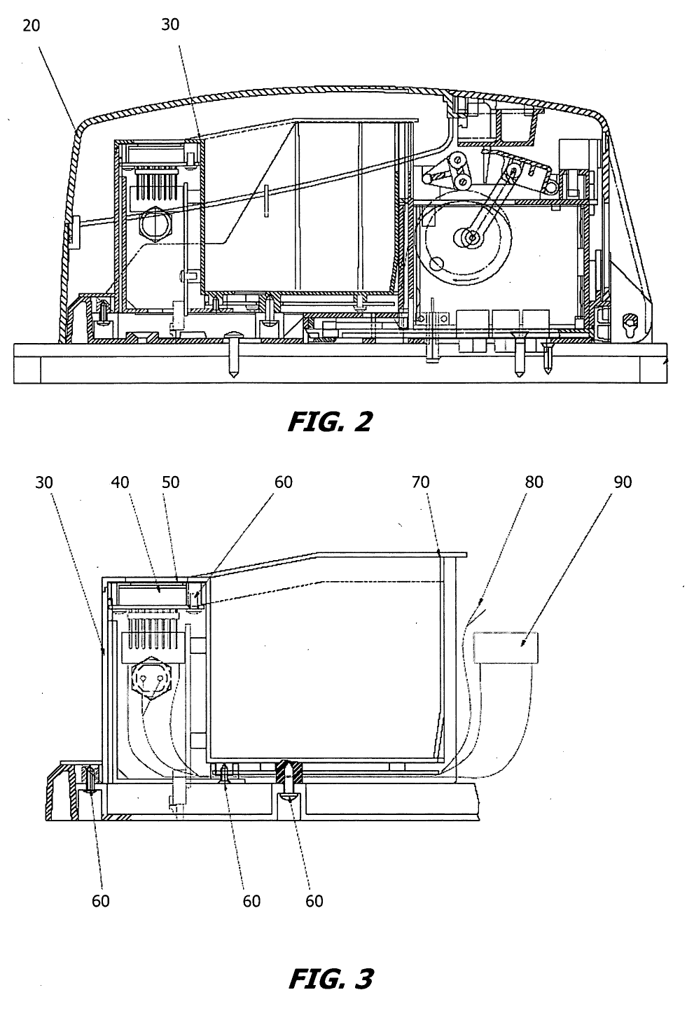

FIG. 2 shows a representative dispenser unit 20 according to the present invention. Base unit 30 is connected to dispenser unit 20.

FIG. 3 shows a representative base unit 30 according to an embodiment of the present invention. Base unit 30 comprises a liquid crystal display 40 and a liquid crystal display screen 50. Base unit 30 is held together with screws 60. Liquid crystal display 40 and liquid crystal display screen 50 are protected by a cover 70. A key-switch pigtail 80 and a liquid crystal display cable 90 allow base unit 20 to communicate with remote devices (not shown).

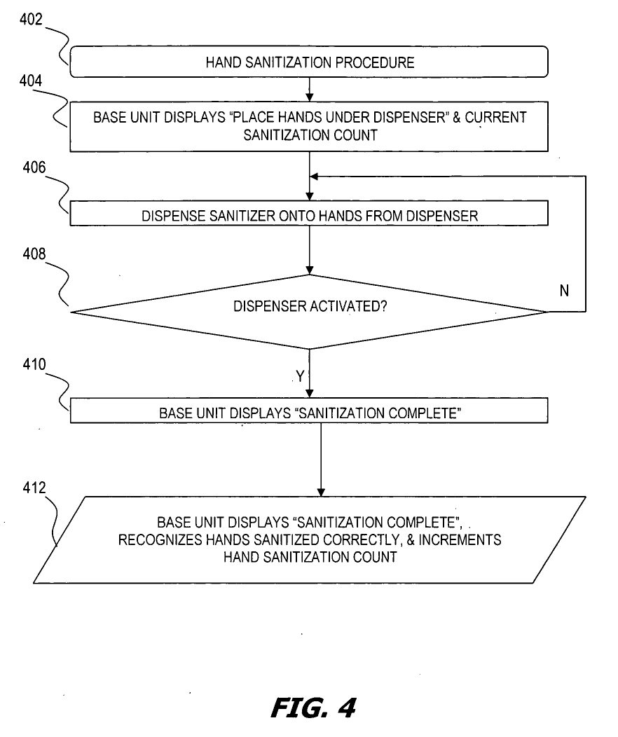

FIG. 4 is a flow chart diagram showing the overall operation of a hand sanitization procedure according to an embodiment of the present invention. The procedure begins at step 402 when a person determines that it is necessary to sanitize her hands.

In step 404, a base unit 30 displays a current sanitization count and instructs the person to place her hands under a dispenser unit 20 with the prompt “PLACE HANDS UNDER DISPENSER.” In step 406, the dispenser unit 20 dispenses sanitizer onto the person's hands when the person places her hand under the dispenser unit 20.

If the base unit 30 receives a signal from the dispenser unit 20 indicating it was activated in step 408, the procedure goes to the next step. Otherwise, the base unit 30 displays the prompt “PLACE HANDS UNDER DISPENSER” until the person complies.

After receiving a signal from the dispenser unit 20 in step 408, the base unit 30 displays the “SANITIZATION COMPLETE” prompt for a predetermined time. During this predetermined time, any further activation of the dispenser unit 20 will not register with the base unit 30.

After the predetermined time elapses, the base unit 30 resets the procedure to the beginning and increments the sanitization count in step 412.

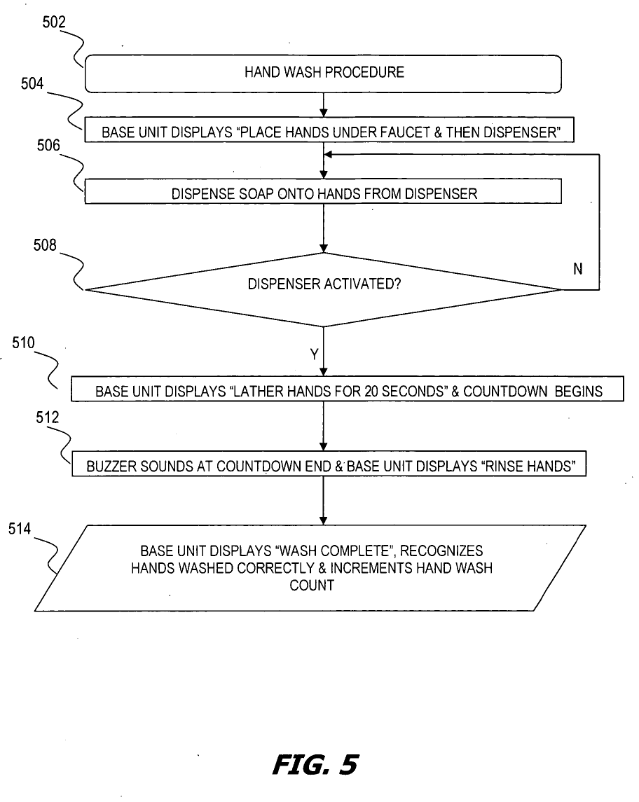

FIG. 5 is a flow chart diagram showing the overall operation of a hand wash and sanitization procedure according to an embodiment of the present invention. The procedure begins at step 502 when a person determines that it is necessary to wash her hands.

In step 504, a base unit 30 displays a current wash count. Base unit 30 also instructs the person to wet her hands using a faucet 10 with the prompt “PLACE HANDS UNDER FAUCET & THEN DISPENSER.” In step 506, the dispenser unit 20 dispenses soap onto the person's hands when the person places her hands under the dispenser unit 20.

If the base unit 30 receives a signal from the dispenser unit 20 indicating it was activated in step 508, the procedure goes to the next step. Otherwise, the base unit 30 displays the prompt “PLACE HANDS UNDER FAUCET & THEN DISPENSER” until the person complies.

After receiving a signal from the dispenser unit 20 in step 508, the base unit 30 instructs the person with the prompt “LATHER HANDS FOR 20 SECONDS” in step 510. During this time period, any further activation of the dispenser unit 20 will not register with the base unit 30. The base unit 30 deactivates the faucet 10 during this time period to assure that the person properly lathers her hands. Also in step 510, the base unit 30 initiates and displays a countdown sequence from twenty seconds to zero seconds.

In step 512, base unit 30 sounds an audible alarm at the end of the countdown sequence and instructs the person with the prompt “RINSE HANDS” for a predetermined time. The base unit 30 reactivates the faucet 10 to allow the person to rinse her hands. During this predetermined time, any further activation of the dispenser unit 20 will not register with the base unit 30.

After the predetermined time elapses, the base unit 30 displays the prompt “WASH COMPLETE,” resets the procedure to the beginning, and increments the wash count in step 512.

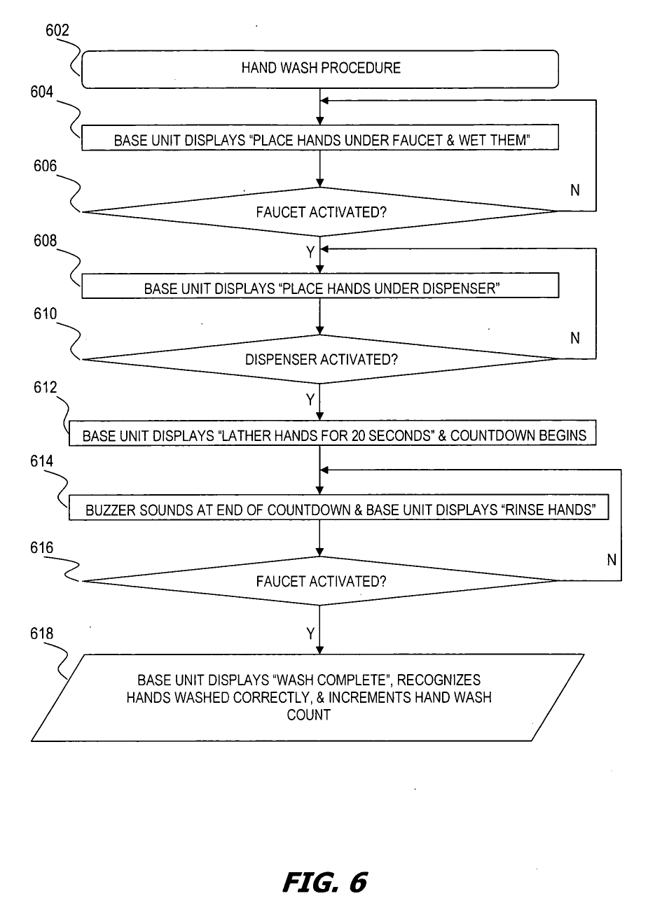

FIG. 6 is a flow chart diagram showing the overall operation of a hand wash and sanitization procedure according to an embodiment of the present invention. The procedure begins at step 602 when a person determines that it is necessary to sanitize her hands.

In step 604, a base unit 30 displays a current wash count. Base unit 30 also instructs the person with the prompt “PLACE HANDS UNDER FAUCET & WET THEM.” A faucet 10 dispenses water onto the person's hands when the person places her hands under the faucet 10. In step 606, if the base unit 30 receives a signal from the faucet 10 indicating it was activated, the procedure goes to the next step. Otherwise, the base unit 30 displays the prompt “PLACE HANDS UNDER FAUCET & WET THEM” until the person complies. If the person fails to comply within a predetermined time, the base unit 30 resets the procedure to the beginning but does not increment the wash count.

In step 608, base unit 30 instructs the person with the prompt “PLACE HANDS UNDER DISPENSER.” A dispenser unit 20 dispenses soap onto the person's hands when the person places her hands under the dispenser unit 20. In step 610, if the base unit 30 receives a signal from the dispenser unit 20 indicating it was activated, the procedure goes to the next step. Otherwise, the base unit 30 displays the prompt “PLACE HANDS UNDER DISPENSER” until the person complies. If the person fails to comply within a predetermined time, the base unit 30 resets the procedure to the beginning but does not increment the wash count.

After receiving a signal from the dispenser unit 20 in step 610, the base unit 30 instructs the person with the prompt “LATHER HANDS FOR 20 SECONDS” in step 612. During this time period, any further activation of the dispenser unit 20 will not register with the base unit 30. The base unit 30 deactivates the faucet 10 during this time period to assure that the person properly lathers her hands. Also in step 612, the base unit 30 initiates and displays a countdown sequence from twenty seconds to zero seconds.

In step 614, base unit 30 sounds an audible alarm at the end of the countdown sequence and instructs the person with the prompt “RINSE HANDS” for a predetermined time. The base unit 30 reactivates the faucet 10 to allow the person to rinse her hands. The faucet 10 dispenses water onto the person's hands when the person places her hands under the faucet 10. During this predetermined time, any further activation of the dispenser unit 20 will not register with the base unit 30.

In step 616, if the base unit 30 receives a signal from the faucet 10 indicating it was activated, the procedure goes to the next step. Otherwise, the base unit 30 displays the prompt “RINSE HANDS” until the person complies. If the person fails to comply within a predetermined time, the base unit 30 resets the procedure to the beginning but does not increment the wash count.

After the base unit 30 receives a signal from the faucet 10, the base unit 30 displays the prompt “WASH COMPLETE,” resets the procedure to the beginning, and increments the wash count in step 618.

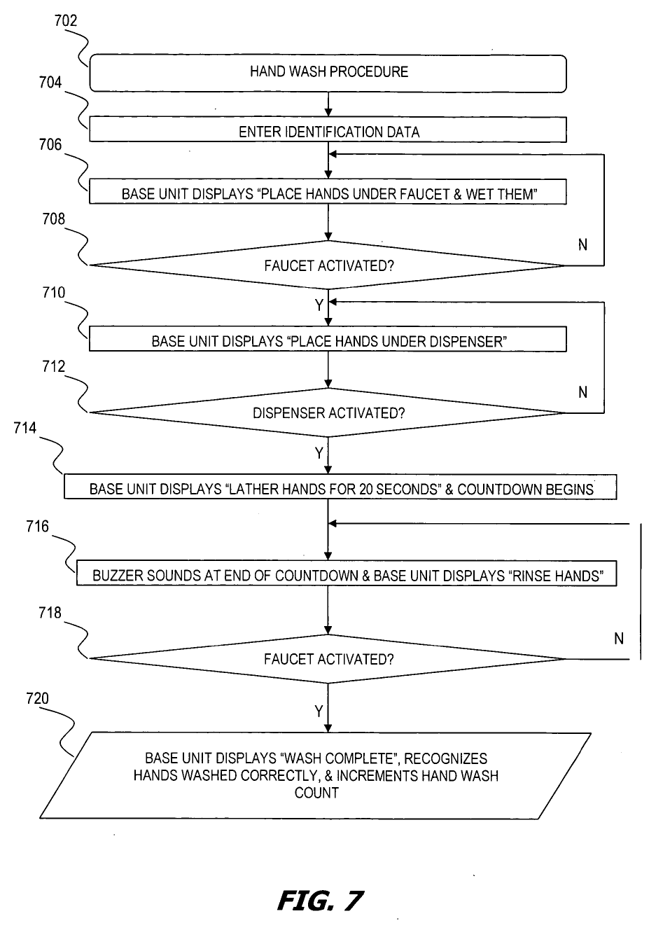

FIG. 7 is a flow chart diagram showing the overall operation of a hand wash and sanitization procedure according to an embodiment of the present invention. The procedure begins at step 702 when a person determines that it is necessary to sanitize her hands. In step 704, the person enters her identification data.

In step 706, a base unit 30 displays a current wash count. Base unit 30 also instructs the person with the prompt “PLACE HANDS UNDER FAUCET & WET THEM.” A faucet 10 dispenses water onto the person's hands when the person places her hands under the faucet 10. In step 708, if the base unit 30 receives a signal from the faucet 10 indicating it was activated, the procedure goes to the next step. Otherwise, the base unit 30 displays the prompt “PLACE HANDS UNDER FAUCET & WET THEM” until the person complies. If the person fails to comply within a predetermined time, the base unit 30 resets the procedure to the beginning but does not increment the wash count.

In step 710, base unit 30 instructs the person with the prompt “PLACE HANDS UNDER DISPENSER.” A dispenser unit 20 dispenses soap onto the person's hands when the person places her hands under the dispenser unit 20. In step 712, if the base unit 30 receives a signal from the dispenser unit 20 indicating it was activated, the procedure goes to the next step. Otherwise, the base unit 30 displays the prompt “PLACE HANDS UNDER DISPENSER” until the person complies. If the person fails to comply within a predetermined time, the base unit 30 resets the procedure to the beginning but does not increment the wash count.

After receiving a signal from the dispenser unit 20 in step 712, the base unit 30 instructs the person with the prompt “LATHER HANDS FOR 20 SECONDS” in step 714. During this time period, any further activation of the dispenser unit 20 will not register with the base unit 30. The base unit 30 deactivates the faucet 10 during this time period to assure that the person properly lathers her hands. Also in step 714, the base unit 30 initiates and displays a countdown sequence from twenty seconds to zero seconds.

In step 716, base unit 30 sounds an audible alarm at the end of the countdown sequence and instructs the person with the prompt “RINSE HANDS” for a predetermined time. The base unit 30 reactivates the faucet 10 to allow the person to rinse her hands. The faucet 10 dispenses water onto the person's hands when the person places her hands under the faucet 10. During this predetermined time, any further activation of the dispenser unit 20 will not register with the base unit 30.

In step 718, if the base unit 30 receives a signal from the faucet 10 indicating it was activated, the procedure goes to the next step. Otherwise, the base unit 30 displays the prompt “RINSE HANDS” until the person complies. If the person fails to comply within a predetermined time, the base unit 30 resets the procedure to the beginning but does not increment the wash count.

After the base unit 30 receives a signal from the faucet 10, the base unit 30 displays the prompt “WASH COMPLETE,” resets the procedure to the beginning, and increments the wash count in step 720.

In general, any deviation from the procedure will cause the base unit 30 to repeat the entire procedure. Only upon completion of the entire procedure is the base unit 30 signaled to increment the sanitization count. The internal memory of the base unit 30 stores statistics regarding current and past hand washing procedures, along with the identification data of the person performing the hand washing procedure if applicable. The statistics could include a number of items such as time, date, whether the hand washing was successfully performed, the number of attempts needed to successfully perform the hand washing procedure, portions of the procedure that needed to be repeated, etc. This data can later be retrieved or transmitted to maintain and output a history record or conformance report for each person, if applicable. Transmitting the data to a remote computer may be accomplished by wired or wireless transmission. The predetermined time periods of 20 seconds recited in the above embodiments may be modified by an end user according to her needs using the base unit 30.

The above invention has been described with specific embodiments, but a person skilled in the art could introduce many variations on these embodiments without departing from the spirit of the disclosure or from the scope of the appended claims. The embodiments are presented for the purpose of illustration only and should not be read as limiting the invention or its application. Therefore, the claims should be interpreted commensurate with the spirit and scope of the invention.

We claim:

1. A hand wash and sanitization monitoring system comprising:
a wash area including a faucet and a dispenser for washing and sanitizing hands of a person; and
a base unit connected to the faucet and the dispenser for detecting when the person has correctly performed a predetermined hand wash procedure, whereupon said base unit advances a wash count.

2. The hand wash and sanitization monitoring system as set forth in claim 1, wherein the dispenser dispenses soap.

3. The hand wash and sanitization monitoring system as set forth in claim 1, wherein the dispenser dispenses sanitizing solution.

4. The hand wash and sanitization monitoring system as set forth in claim 1, wherein said base unit is equipped with one or more of visual means and audible means for prompting the person to perform the predetermined hand wash procedure.

5. The hand wash and sanitization monitoring system as set forth in claim 1, further comprising means for preventing reactivation of the predetermined hand wash procedure for a predetermined period of time upon the base unit detecting the person has correctly performed the predetermined hand wash procedure.

6. The hand wash and sanitization monitoring system as set forth in claim 1, wherein said base unit stores performance data regarding the predetermined hand wash procedure for one of later retrieval, immediate transmission and delayed transmission to a remote memory unit.

7. The hand wash and sanitization monitoring system as set forth in claim 6, wherein said base unit is equipped with one or more of communication means for communicating performance data regarding the predetermined hand wash procedure to the remote memory unit.

8. The hand wash and sanitization monitoring system as set forth in claim 1, wherein the faucet and soap dispenser in said wash area are activated by one of hand proximity sensors and non-contaminating means.

9. The hand wash and sanitization monitoring system as set forth in claim 1, further comprising means for inputting identification data of persons.

10. The hand wash and sanitization monitoring system as set forth in claim 1, further comprising means for deactivating the faucet for a predetermined period of time upon the base unit detecting the person has correctly performed a step of the predetermined hand wash procedure.

11. A hand wash monitoring method comprising the steps of:
instructing a person to perform a predetermined hand wash procedure using a base unit;
detecting whether the person has properly performed the predetermined hand wash procedure using the base unit; and
advancing a wash count using the base unit when the person has properly performed the predetermined hand wash procedure.

11. The hand wash and sanitization monitoring method according to claim 11, wherein said instructing step further includes the step of one or more of visually and audibly prompting the person to perform the predetermined hand wash procedure by the base unit.

12. The hand wash and sanitization monitoring method according to claim 11, wherein said hand wash and sanitization monitoring method further comprising the step of preventing reactivation of the predetermined hand wash procedure for a predetermined period of time upon the base unit detecting the person has correctly performed the predetermined hand wash procedure.

13. The hand wash and sanitization monitoring method according to claim 11, wherein said hand wash and sanitization monitoring method further comprising the step of storing performance data of persons regarding the predetermined hand wash procedure to the base unit for one of later retrieval, immediate transmission and delayed transmission to a remote memory unit.

14. The hand wash and sanitization monitoring method according to claim 11, wherein said hand wash and sanitization monitoring method further comprising the step of communicating performance data of persons regarding the predetermined hand wash procedure to the remote memory unit.

15. The hand wash and sanitization monitoring method according to claim 11, wherein said hand wash and sanitization monitoring method further comprises instructing the person to enter identification data.

16. The hand wash and sanitization monitoring method according to claim 11, wherein said hand wash and sanitization monitoring method further comprises deactivating the faucet for a predetermined period of time upon the base unit detecting the person has correctly performed a step of the predetermined hand wash procedure.
